(19) United States
(12) Patent Application Publication
(10) Pub. No.: US 2021/0162794 A1
(43) Pub. Date: Jun. 3, 2021

(54) OPTICAL ANTI-COUNTERFEITING ELEMENT AND MANUFACTURING METHOD THEREFOR, AND OPTICAL ANTI-COUNTERFEITING PRODUCT

(71) Applicants: ZHONGCHAO SPECIAL SECURITY TECHNOLOGY CO., LTD, Beijing (CN); CHINA BANKNOTE PRINTING AND MINTING CORP., Beijing (CN)

(72) Inventors: Chunhua HU, Beijing (CN); Jun ZHU, Beijing (CN); Weiwei ZHANG, Beijing (CN); Baoli ZHANG, Beijing (CN); Yan LI, Beijing (CN)

(21) Appl. No.: 17/048,137

(22) PCT Filed: Apr. 8, 2019
(86) PCT No.: PCT/CN2019/081724

§ 371 Date: Oct. 16, 2020

(30) Foreign Application Priority Data
Jul. 13, 2018 (CN) 201810770939.4

(51) Int. Cl. B42D 25/328; B42D 25/45; G02B 5/18

(52) U.S. Cl. CPC B42D 25/328; B42D 25/351; G02B 5/1814; B42D 25/45

(57) ABSTRACT

Embodiments of the present invention provide an optical anti-counterfeiting element and a preparation method thereof, and an optical anti-counterfeiting product, and belong to the field of optical anti-counterfeiting. The optical anti-counterfeiting element comprises: a transparent undulating structure layer, comprising a first undulating structure and a second undulating structure, wherein the first undulating structure and the second undulating structure meet the following conditions: the depth-to-width ratio of the first undulating structure is less than that of the second undulating structure, and/or the specific volume of the first undulating structure is less than that of the second undulating structure; and an interference optically variable coating, formed on the first undulating structure, wherein when the interference optically variable coating is observed from two sides, optically variable effects are presented at the two sides, and when the optical anti-counterfeiting element is observed through transmission, an image defined by the boundary of the second undulating structure is presented. Therefore, the optical anti-counterfeiting element can simultaneously present image effects and optically variable effects when being observed from two sides and has a hollowed-out effect when being observed through transmission.

### FIELD OF THE INVENTION

The present invention relates to the field of optical anti-counterfeiting, and in particular, to an optical anti-counterfeiting element and a preparation method thereof, and an optical anti-counterfeiting product.

### BACKGROUND OF THE INVENTION

In order to prevent counterfeiting by means of scanning and copying, optical anti-counterfeiting technologies have been widely used in various high-security or high-value-added printed matter such as banknotes, credit cards, passports and negotiable securities, and have achieved very good results, such as security strips and anti-counterfeiting wide strips in banknotes.

In recent years, optical anti-counterfeiting products with window structures have been widely used. When you observe such a product from the front and reverse sides and even observe it through transmission, different visual effects are displayed. Therefore, the anti-counterfeiting strength is greatly enhanced. For example, the latest version of 20-euro note adopts an anti-counterfeiting wide strip with a window structure. When you observe the anti-counterfeiting wide strip from the front and reverse sides, different holographic digital images are displayed. When you observe the anti-counterfeiting wide strip through transmission, a hollowed-out Europa portrait is displayed. As the 20-euro note has a strong visual impact, the anti-counterfeiting effect is excellent. For another example, the latest version of 5-pound plastic note has an anti-counterfeiting wide strip. When you observe the anti-counterfeiting wide strip from the front and reverse sides, a tower in a window part of the anti-counterfeiting wide strip has different colors. When you observe the anti-counterfeiting wide strip through transmission, the background of the tower has a hollowed-out transparent effect. In addition, multi-coating interference optically variable technologies have strong optically variable effects at different observation viewing angles, thereby getting more and more people's attention. Generally, vapor deposition is used in the multi-coating interference optically variable technologies to realize the evaporation of a reflection layer, a dielectric layer and a partially transparent layer (also referred to as an absorption layer). The three-layer structure composed of the reflection layer, the dielectric layer and the partially transparent layer is a basic element of a common interference optically variable coating. When you observe the partially transparent layer from one side, different color features are displayed at different angles. For example, the security strip of a 100-yuan banknote of the fifth set dated 2015 adopts a multi-layer interference optically variable technology, is magenta when being observed vertically, and is green when being observed slantly. Combining of a micro-structural optical anti-counterfeiting technology with a multi-layer interference optically variable technology can effectively give full play to the dual advantages of an optical image (such as a holographic image) presented by a microstructure and optically variable effects presented by a multi-layer coating, thereby further enhancing the anti-counterfeiting effect. Security strips in space commemorative banknotes issued in 2015 adopt an optical anti-counterfeiting technology integrating an optical microstructure and a multi-layer interference optically variable structure.

It can be expected that if a product has both image effects and optically variable effects when being observed from two sides and has a partially hollowed-out effect when being observed through transmission and that the hollowed-out area is accurately aligned with an image, the anti-counterfeiting effect can be greatly improved, and the product has a good application prospect in a scenario with a window feature (such as a window on a banknote). However, such products are unavailable at present.

### SUMMARY OF THE INVENTION

The present invention aims to provide an optical anti-counterfeiting element and a preparation method thereof, and an optical anti-counterfeiting product, wherein the optical anti-counterfeiting element can simultaneously present image effects and optically variable effects when being observed from two sides and has a partially hollowed-out effect when being observed through transmission, and the hollowed-out area is accurately aligned with an image.

To achieve the foregoing objective, an aspect of the present invention provides an optical anti-counterfeiting element. The optical anti-counterfeiting element comprises: a transparent undulating structure layer, comprising a first undulating structure and a second undulating structure, wherein the first undulating structure and the second undulating structure meet the following conditions: the depth-to-width ratio of the first undulating structure is less than that of the second undulating structure, and/or the specific volume of the first undulating structure is less than that of the second undulating structure; and an interference optically variable coating, formed on the first undulating structure, wherein the interference optically variable coating presents optically variable effects when being observed from two sides, and an image defined by the boundary of the second undulating structure is presented when the optical anti-counterfeiting element is observed through transmission.

Optionally, the optical anti-counterfeiting element further comprises: a transparent substrate, wherein the undulating structure layer is formed on at least part of the substrate.

Optionally, the interference optically variable coating comprises a first partially transparent layer, a first dielectric layer, a reflection layer, a second dielectric layer and a second partially transparent layer that are overlapped in sequence.

Optionally, the first partially transparent layer is different from the second partially transparent layer, and/or the first dielectric layer is different from the second dielectric layer.

Optionally, the interference optically variable coating comprises a first partially transparent layer, a dielectric layer and a second partially transparent layer that are overlapped in sequence.

Optionally, the first partially transparent layer is different from the second partially transparent layer. To achieve the foregoing objective, an aspect of the present invention provides an optical anti-counterfeiting product, characterized by comprising above optical anti-counterfeiting element.

To achieve the foregoing objective, an aspect of the present invention provides a preparation method of an optical anti-counterfeiting element, characterized by comprising: forming a transparent undulating structure layer on at least part of a substrate, wherein the transparent undulating structure layer comprises a first area and a second area with a first undulating structure and a second undulating structure located therein respectively, and the first undulating structure and the second undulating structure meet the following conditions: the depth-to-width ratio of the first undulating structure is less than that of the second undulating structure, and/or the specific volume of the first undulating structure is less than that of the second undulating structure; and forming an interference optically variable coating on the first undulating structure, wherein the interference optically variable coating presents optically variable effects when being observed from two sides, and an image defined by the boundary of the second undulating structure is presented when the optical anti-counterfeiting element is observed through transmission.

Optionally, when the depth-to-width ratio of the first undulating structure is less than that of the second undulating structure, the specific volume of the first undulating structure is less than that of the second undulating structure, and the outermost layer, far away from the first undulating structure, of the interference optically variable coating does not react with a corrosive atmosphere, the step of forming an interference optically variable coating on the first undulating structure comprises: forming the interference optically variable coating on the undulating structure layer, wherein the interference optically variable coating at least covers the first undulating structure; and placing a structure formed by the substrate, the undulating structure layer and the interference optically variable coating in the corrosive atmosphere till the part, covering the second area, of the interference optically variable coating is completely or partially corroded; or forming the interference optically variable coating on the undulating structure layer, wherein the interference optically variable coating at least covers the first undulating structure; coating the interference optically variable coating with a coating, wherein the coating at least covers the part, corresponding to the first undulating structure, of the interference optically variable coating, so as to protect the part, covering the first undulating structure, of the interference optically variable coating from being corroded by the corrosive atmosphere; and placing a structure formed by the substrate, the undulating structure layer and the interference optically variable coating in the corrosive atmosphere till the part, covering the second area, of the interference optically variable coating is completely or partially corroded.

Optionally, when the depth-to-width ratio of the first undulating structure is less than that of the second undulating structure, the specific volume of the first undulating structure is greater than that of the second undulating structure, and the outermost layer, far away from the first undulating structure, of the interference optically variable coating does not react with a corrosive atmosphere, the step of forming an interference optically variable coating on the first undulating structure comprises: forming the interference optically variable coating on the undulating structure layer, wherein the interference optically variable coating at least covers the first undulating structure; and placing a structure formed by the substrate, the undulating structure layer and the interference optically variable coating in the corrosive atmosphere till the part, covering the second area, of the interference optically variable coating is completely or partially corroded.

Optionally, when the depth-to-width ratio of the first undulating structure is greater than that of the second undulating structure, and/or the outermost layer, far away from the first undulating structure, of the interference optically variable coating reacts with a corrosive atmosphere, the specific volume of the first undulating structure is less than that of the second undulating structure, and the step of forming an interference optically variable coating on the first undulating structure comprises: forming the interference optically variable coating on the undulating structure layer, wherein the interference optically variable coating at least covers the first undulating structure: coating the interference optically variable coating with a coating, wherein the coating at least covers the part, corresponding to the first undulating structure, of the interference optically variable coating, so as to protect the part, covering the first undulating structure, of the interference optically variable coating from being corroded by the corrosive atmosphere; and placing a structure formed by the substrate, the undulating structure layer and the interference optically variable coating in the corrosive atmosphere till the part, covering the second area, of the interference optically variable coating is completely or partially corroded.

Optionally, the interference optically variable coating comprises a first partially transparent layer, a first dielectric layer, a reflection layer, a second dielectric layer and a second partially transparent layer that are overlapped in sequence.

Optionally, the first partially transparent layer is different from the second partially transparent layer, and/or the first dielectric layer is different from the second dielectric layer.

Optionally, the interference optically variable coating comprises a first partially transparent layer, a dielectric layer and a second partially transparent layer that are overlapped in sequence.

Optionally, the first partially transparent layer is different from the second partially transparent layer. According to the foregoing technical solution, due to the transparent undulating structure layer, the optical anti-counterfeiting element presents image effects when being observed from two sides; and due to the interference optically variable coating, the optical anti-counterfeiting element presents optically variable effects when being observed from two sides. Therefore, the optical anti-counterfeiting element can simultaneously present image effects and optically variable effects when being observed from two sides. The part, located in the second undulating structure area, of the interference optically variable coating is partially or completely removed, so that when the anti-counterfeiting element is observed through transmission, an image defined by the boundary of the second undulating structure is presented, that is, the hollowed-out area is completely aligned with an image defined by the second undulating structure.

Other characteristics and advantages of the present invention are described in detail in the following “Detailed Description of the Embodiments” section.

### BRIEF DESCRIPTION OF DRAWINGS

The accompanying drawings are used to provide a further understanding of the embodiments of the present invention and constitute a part of this Description. In combination with the following specific implementations, the accompanying drawings are used to describe embodiments of the present invention, but do not impose any limitation to the embodiments of the present invention. The accompanying drawings are as follows:

FIG. 1 is a structural schematic diagram of an optical anti-counterfeiting element provided by an embodiment of the present invention;

FIG. 2 is a schematic top view of an example optical anti-counterfeiting element provided by another embodiment of the present invention;

FIG. 3a is a schematic view of one cross section of the optical anti-counterfeiting element shown in FIG. 2 along the X-X line shown in FIG. 2 provided by another embodiment of the present invention;

FIG. 3b is a schematic view of another cross section of the optical anti-counterfeiting element shown in FIG. 2 along the X-X line shown in FIG. 2 provided by another embodiment of the present invention;

FIG. 4 is a flowchart of a preparation method of an optical anti-counterfeiting element provided by another embodiment of the present invention;

FIG. 5 to FIG. 7 are schematic cross-sectional views of an optical anti-counterfeiting element having the cross section shown in FIG. 3a during preparation provided by another embodiment of the present invention; and

FIG. 8 and FIG. 9 are schematic cross-sectional views of an optical anti-counterfeiting element having the cross section shown in FIG. 3a during preparation provided by another embodiment of the present invention.

Reference numerals are described as follows:
1: Substrate; 2: Undulating structure layer
3: Interference optically variable coating; 31: First partially transparent layer
32: First dielectric layer: 33: Reflection layer
34: Second dielectric layer, 35: Second partially transparent layer
36: Dielectric layer; 4: Functional coating
5: Coating

### DETAILED DESCRIPTION OF THE EMBODIMENTS

The specific implementations of embodiments of the present invention will be described in detail in conjunction with the accompanying drawings. It should be understood that the specific implementations described herein are merely used to illustrate and explain the embodiments of the present invention and are not used to limit the embodiments of the present invention.

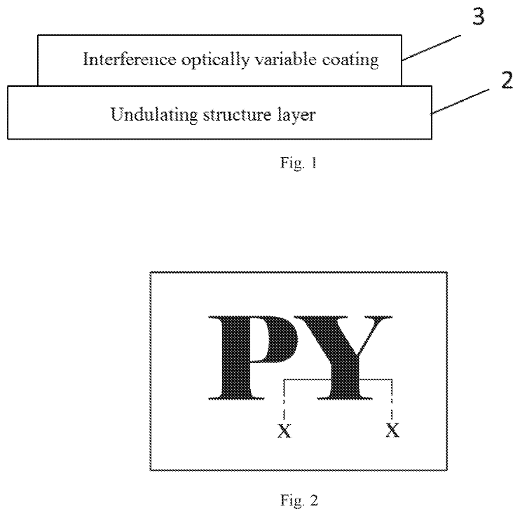

According to one aspect of the embodiments of the present invention, an optical anti-counterfeiting element is provided. FIG. 1 is a structural schematic diagram of an optical anti-counterfeiting element provided by an embodiment of the present invention. As shown in FIG. 1, the optical anti-counterfeiting element comprises an undulating structure layer 2 and an interference optically variable coating 3, wherein the undulating structure layer 2 is transparent and comprises undulating structures; and the interference optically variable coating 3 is formed on at least part of the undulating structure layer 2 and presents optically variable effects when being observed from two sides.

Due to the undulating structure layer, the optical anti-counterfeiting element presents image effects when being observed from two sides. Due to the interference optically variable coating, the optical anti-counterfeiting element presents optically variable effects when being observed from two sides. Therefore, the optical anti-counterfeiting element can simultaneously present image effects and optically variable effects when being observed from two sides, that is, the anti-counterfeiting property of the optical anti-counterfeiting element is improved. The undulating structure layer comprises a first undulating structure and a second undulating structure. The interference optically variable coating covers the first undulating structure. Therefore, the optical anti-counterfeiting element has a partially hollowed-out transparent effect when being observed through transmission, and an image defined by the boundary of the second undulating structure can be presented, that is, the hollowed-out area is accurately aligned with the image area. In this way, anti-counterfeiting dimensions of the optical anti-counterfeiting element are increased, so that the anti-counterfeiting property of the optical anti-counterfeiting element is further improved.

In addition, due to the undulating structures in the undulating structure layer, the optical anti-counterfeiting element presents an image effect when being observed, and the image effect presented when the optical anti-counterfeiting element is observed can be changed by changing the undulating structures. In the embodiment of the present invention, cross sections of the first undulating structure and/or the second undulating structure can be of cosine structures, zigzag structures, cylindrical structures, spherical structures, pyramidal structures, square-wave structures, or a combination thereof.

The first undulating structure and the second undulating structure should meet the following conditions: the depth-to-width ratio of the first undulating structure is less than that of the second undulating structure, and/or the specific volume of the first undulating structure is less than that of the second undulating structure. When the first undulating structure and the second undulating structure meet the foregoing conditions, accurate hollowing out can be realized during preparation of the optical anti-counterfeiting element, that is, the interference optically variable coating accurately covers only the first undulating structure, the hollowed-out area is accurately aligned with an image defined by the first undulating structure. The depth-to-width ratio of the undulating structure refers to the ratio of the depth of the undulating structure to the width of the undulating structure in the direction of the period. The specific volume of the undulating structure refers to the ratio of the volume of a liquid that just completely covers the surface of the undulating structure when the undulating structure layer is arranged horizontally to the projected area of the undulating structure on a horizontal surface. According to this definition, the depth-to-width ratio is a dimensionless physical quantity, and the dimension of the specific volume is um³/um²; and a flat structure is regarded as an undulating structure whose depth-to-width ratio and specific volume are zero. Depth-to-width ratio and specific volume are two physical quantities that are not directly related to each other in quantity. For example, if a structure A is a one-dimensional zigzag grating being 1 um in depth and 1 um in period, its depth-to-width ratio is 1, and its specific volume is 0.5 um³/um²; if a structure B is a one-dimensional zigzag grating being 2 um in depth and 4 um in period, its depth-to-width ratio is 0.5, and its specific volume is 1 um³/um². In other words, the depth-to-width ratio of the structure A is greater than that of the structure B, but the specific volume of the structure B is greater than that of the structure A. In addition, different hollowing out procedures can be adopted according to the differences of depth-to-width ratios and specific volumes of the first undulating structure and the second undulating structure.

Optionally, in the embodiment of the present invention, the optical anti-counterfeiting element can further comprise a substrate that is at least partially transparent. The undulating structure layer is formed on at least part of the substrate.

Optionally, in the embodiment of the present invention, the first undulating structure and the second undulating structure can be completely or partially periodic, wherein the period can be greater than 1 um and less than 20 um. The periodicity of the first undulating structure is for the shaping of the optical effect presented by the first undulating structure, and the periodicity of the second undulating structure is for the formation of the hollowed-out feature.

Optionally, in the embodiment of the present invention, the depth-to-width ratio of the first undulating structure is less than 0.3, and the depth-to-width ratio of the second undulating structure is greater than 0.3. Preferably, the depth-to-width ratio of the first undulating structure is less than 0.2, and the depth-to-width ratio of the second undulating structure is greater than 0.5.

Optionally, in the embodiment of the present invention, the specific volume of the first undulating structure is less than 1 um³/um², and the specific volume of the second undulating structure is greater than 1 um³/um². Preferably, the specific volume of the first undulating structure is less than 0.5 um³/um², and the specific volume of the second undulating structure is greater than 0.5 um³/um².

Optionally, in the embodiment of the present invention, the interference optically variable coating can comprise a first partially transparent layer, a first dielectric layer, a reflection layer, a second dielectric layer and a second partially transparent layer that are overlapped in sequence. In the five-layer structure, the dielectric layers and the partially transparent layers are respectively arranged on two sides of the reflection layer. Therefore, when the interference optically variable coating is observed from two sides, optically variable effects are presented at the two sides. In addition, the first partially transparent layer can be the same as or different from the second partially transparent layer, and the first dielectric layer can be the same as or different from the second dielectric layer. In the case that the first partially transparent layer is different from the second partially transparent layer, and/or the first dielectric layer is different from the second dielectric layer, when the optical anti-counterfeiting element is observed from two sides, optically variable color effects presented by the two sides are different. For example, the effect of changing between color A and color B is presented at one side; and the effect of changing between color C and color D is presented at the other side.

Optionally, the interference optically variable coating can alternatively comprise a first partially transparent layer, a dielectric layer and a second partially transparent layer that are overlapped in sequence. In the three-layer structure, the second partially transparent layer provides a reflection layer on one side of the interference optically variable coating, and the first partially transparent layer provides a reflection layer on the other side of the interference optically variable coating. Therefore, when the interference optically variable coating is observed from two sides, optically variable effects are presented at the two sides. In addition, the first partially transparent layer can be the same as or different from the second partially transparent layer. In the case that the first partially transparent layer is different from the second partially transparent layer, when the optical anti-counterfeiting element is observed from two sides, optically variable color effects presented by the two sides are different.

Optionally, in the embodiment of the present invention, a partially transparent layer (the innermost coating) adjacent to the undulating structure layer is made of aluminum or aluminum alloy, so as to obtain a hollowed-out effect. This is because aluminum tends to be removed due to reaction with a variety of corrosive environments, such as a lye or an acid. If the partially transparent layer adjacent to the undulating structure layer is removed due to reaction, other coatings on the partially transparent layer can also be peeled off even if they cannot react with a corrosive environment.

Optionally, in the embodiment of the present invention, the optical anti-counterfeiting element can further comprise a protective layer and/or a functional coating that are/is formed on the side, opposite to the substrate, of the optical anti-counterfeiting element. The protective layer and/or the functional coating can be single-layer or multi-layer. Generally, the protective layer and/or the functional coating have/has a protective effect to protect the interference optically variable coating in a use environment from being corroded by external conditions, and also have/has a bonding function with other substrates, such as paper. In addition, when the optical anti-counterfeiting element comprises both the protective layer and the functional coating, the functional coating is formed on the protective layer.

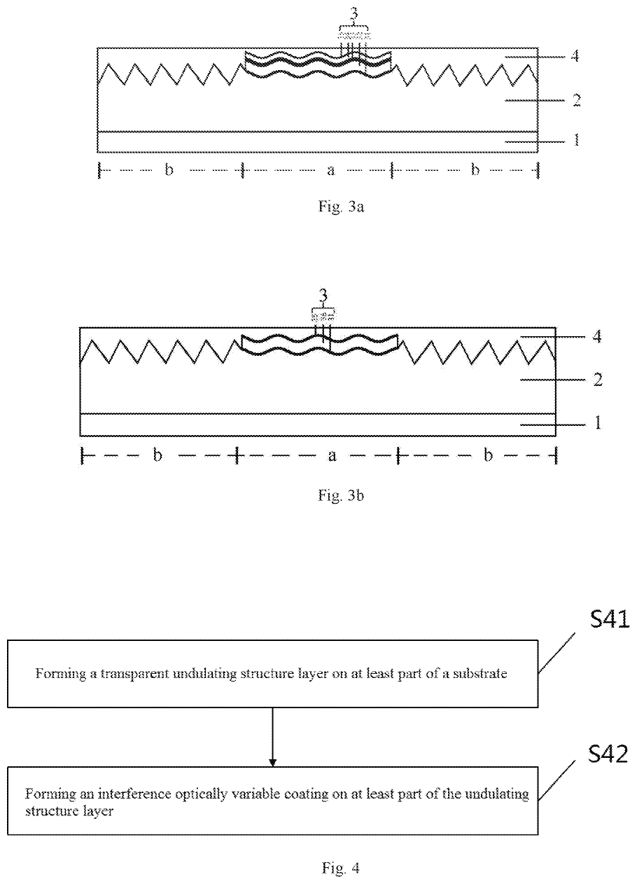

In order to describe the optical anti-counterfeiting element provided by the present invention more vividly, exemplary descriptions of the present invention are given below by using optical anti-counterfeiting elements shown in FIG. 2, FIG. 3a, and FIG. 3b as examples.

FIG. 2 is a schematic top view of an example optical anti-counterfeiting element provided by another embodiment of the present invention. FIG. 3a is a schematic view of one cross section of the optical anti-counterfeiting element shown in FIG. 2 along the X-X line shown in FIG. 2 provided by another embodiment of the present invention. FIG. 3b is a schematic view of another cross section of the optical anti-counterfeiting element shown in FIG. 2 along the X-X line shown in FIG. 2 provided by another embodiment of the present invention. The image part “PY” in FIG. 2 is a display area with the interference optically variable coating, and corresponds to a first area a (comprising the first undulating structure) in FIG. 3a or FIG. 3b. Generally, the display area usually presents images that have special effects and that are prepared using special optical microstructures, such as microstructures with rainbow hologram effects or zigzag grating microstructures with dynamic effects. A background part in FIG. 2 is a hollow-out area with the coating removed. This area has a transparent hollowed-out feature when being observed through transmission, and corresponds to a second area b (comprising the second undulating structure) in FIG. 3a or FIG. 3b. In other words, when this area is observed through transmission, an image defined by the boundary of the second area, that is, an image defined by the boundary of the second undulating structure, can be presented.

Structurally, the optical anti-counterfeiting element shown in FIG. 2 can have two layered structures shown in FIG. 3a and FIG. 3b. The optical anti-counterfeiting element comprises a substrate 1, an undulating structure layer 2, an interference optically variable coating 3 located in the first area a, and other functional coating 4. The interference optically variable coating 3 can be of a five-layer structure, as shown in FIG. 3a. The five-layer structure specifically comprises a first partially transparent layer 31, a first dielectric layer 32, a reflection layer 33, a second dielectric layer 34 and a second partially transparent layer 35 that are overlapped in sequence, as shown in FIG. 3a. In the five-layer structure, the first partially transparent layer 31 and the second partially transparent layer 35 can be made of chromium, nickel, aluminum, silver, copper, tin, titanium, or their alloys. The reflection layer 33 can be made of aluminum, silver, copper, tin, chromium, nickel, titanium, or their alloys. The first dielectric layer 32 and the second dielectric layer 34 can be made of MgF₂, SiO₂, ZnS, TiN, TiO₂, TiO, Ti₂O₃, Ti₃O₅, Ta₂O₅, Nb₂O₅, CeO₂, Bi₂O₃, Cr₂O₃, Fe₂O₃, HfO₂ or ZnO. In the interference optically variable coating 3, the partially transparent layers serve as absorption layers.

The transmittance of the first partially transparent layer 31 and the transmittance of the second partially transparent layer 35 are required to be less than 60%. The reflection layer provides a function of reflecting light and can be relatively thick. For example, the reflectivity of the reflection layer is greater than 90% and the transmittance of the reflection layer is less than 10%. To facilitate obtaining of the hollowed-out effect, the first partially transparent layer 31 adjacent to the undulating structure layer 2 is preferably made of aluminum or aluminum alloy. In addition, the interference optically variable coating 3 can be of a three-layer structure. The three-layer structure specifically comprises a first partially transparent layer 31, a dielectric layer 32 and a second partially transparent layer 35 that are overlapped in sequence, as shown in FIG. 3b. In the three-layer structure, the first partially transparent layer 31 and the second partially transparent layer 35 can be made of chromium, nickel, aluminum, silver, copper, tin, titanium or their alloys: the dielectric layer 36 can be made of MgF₂, SiO₂, ZnS, TiN, TiO₂, TiO, Ti₂O₃, Ti₃O₅, Ta₂O₅, Nb₂O₅, CeO₂, Bi₂O₃, Cr₂O₃, Fe₂O₃, HfO₂ or ZnO; and both the first partially transparent layer 31 and the second partially transparent layer 35 need to have the functions of reflection layers and absorption layers. Therefore, they can neither be too thick nor be too thin. Generally, the transmittance of the first partially transparent layer 31 and the transmittance of the second partially transparent layer 35 are required to be greater than 30% and less than 60%, preferably, greater than 35% and less than 45%. Similarly, to facilitate obtaining of the hollowed-out effect, the first partially transparent layer 31 adjacent to the undulating structure layer 2 is preferably made of aluminum or aluminum alloy. In addition, in the five-layer structure, the reflection layer can be very thick (for example, it is formed through evaporation), that is, the reflectivity is very high. Therefore, colors presented on two sides of the interference optically variable coating 3 comprising the five-layer structure are both very bright. In the three-layer structure, the partially transparent layers on two sides of the interference optically variable coating 3 need to have functions of reflection layers and absorption layers at the same time. Therefore, they can neither be too thick nor be too thin. As a result, colors presented on two sides of the interference optically variable coating 3 comprising the three-layer structure are poor in brightness. However, from another aspect, the three-layer structure is simple in manufacture process and lower in cost. In conclusion, the two modes each has its advantages and disadvantages and can be selected according to different application scenarios. It should be noted that, in FIGS. 3a and 3b of the Description, in the five-layer structure and the three-layer structure, the first partially transparent layers marked with the same reference numeral 31 and the second partially transparent layer marked with the same reference numeral 35 do not indicate that the first partially transparent layers in the five-layer structure and the three-layer structure are of the same type and the second partially transparent layer are of the same type.

In addition, the optical anti-counterfeiting element provided by the embodiment of the present invention can be applied to an optical anti-counterfeiting product as a label, a logo, a wide strip, a transparent window, a security strip with a window, and the like, in particular applied to the optical anti-counterfeiting product as a thermoprinted label.

In addition, another aspect of the embodiments of the present invention provides an optical anti-counterfeiting product, comprising the optical anti-counterfeiting element provided by the foregoing embodiment.

In addition, another aspect of the embodiments of the present invention provides a preparation method of an optical anti-counterfeiting element. FIG. 4 is a flowchart of a preparation method of an optical anti-counterfeiting element provided by another embodiment of the present invention. As shown in FIG. 4, the method comprises the following steps.

Step S41: forming a transparent undulating structure layer on at least part of a substrate, wherein the undulating structure layer comprises undulating structures. The substrate can be at least partially transparent or non-transparent. In the case that the optical anti-counterfeiting element comprises the substrate, the substrate is at least partially transparent. In the case that the optical anti-counterfeiting element does not comprise the substrate, the substrate can be at least partially transparent or non-transparent. For example, when the optical anti-counterfeiting element is placed on an optical anti-counterfeiting product, the substrate needs to be tom off. In this case, there is no requirement on the transparency of the substrate, and the substrate can be at least partially transparent or non-transparent.

Step S42: forming an interference optically variable coating on at least part of the undulating structure layer, wherein the interference optically variable coating is observed from two sides, optically variable effects are presented at the two sides.

Due to the undulating structure layer, when the optical anti-counterfeiting element is observed from two sides, image effects are presented at the two sides. Due to the interference optically variable coating, when the optical anti-counterfeiting element is observed from two sides, optically variable effects are presented at the two sides. Therefore, when the optical anti-counterfeiting element is observed from two sides, both image effects and optically variable effects can be presented at the two sides, that is, the anti-counterfeiting property of the optical anti-counterfeiting element is improved. The undulating structure layer comprises a first undulating structure and a second undulating structure. The interference optically variable coating covers the first undulating structure. Therefore, the optical anti-counterfeiting element has a partially hollowed-out transparent effect when being observed through transmission, and an image defined by the boundary of the second undulating structure can be presented. In this way, anti-counterfeiting dimensions of the optical anti-counterfeiting element are increased, so that the anti-counterfeiting property of the optical anti-counterfeiting element is further improved.

The first undulating structure and the second undulating structure should meet the following conditions: the depth-to-width ratio of the first undulating structure is less than that of the second undulating structure, and/or the specific volume of the first undulating structure is less than that of the second undulating structure. When the first undulating structure and the second undulating structure meet the foregoing conditions, accurate hollowing out is realized during preparation of the optical anti-counterfeiting element, that is, the interference optically variable coating accurately covers only the first undulating structure. In addition, for the specific explanation for the depth-to-width ratio and the specific volume in the embodiment of the preparation method of the optical anti-counterfeiting element provided by the present invention, see the explanation for the corresponding parts in the embodiments of the optical anti-counterfeiting element provided by the present invention.

Optionally, in the embodiment of the present invention, when the depth-to-width ratio of the first undulating structure is less than that of the second undulating structure, the specific volume of the first undulating structure is less than that of the second undulating structure, and the outermost layer, far away from the first undulating structure, of the interference optically variable coating does not react with a corrosive atmosphere, the step of forming an interference optically variable coating on the first undulating structure comprises: forming the interference optically variable coating on the undulating structure layer, wherein the interference optically variable coating at least covers the first undulating structure; and placing a structure formed by the substrate, the undulating structure layer and the interference optically variable coating in the corrosive atmosphere till the part, covering the second area, of the interference optically variable coating is completely or partially corroded; or forming the interference optically variable coating on the undulating structure layer, wherein the interference optically variable coating at least covers the first undulating structure; coating the interference optically variable coating with a coating, wherein the coating at least covers the part, corresponding to the first undulating structure, of the interference optically variable coating, so as to protect the part, covering the first undulating structure, of the interference optically variable coating from being corroded by the corrosive atmosphere; and placing a structure formed by the substrate, the undulating structure layer and the interference optically variable coating in the corrosive atmosphere till the part, covering the second area, of the interference optically variable coating is completely or partially corroded.

Optionally, in the embodiment of the present invention, when the depth-to-width ratio of the first undulating structure is less than that of the second undulating structure, the specific volume of the first undulating structure is greater than that of the second undulating structure, and the outermost layer, far away from the first undulating structure, of the interference optically variable coating does not react with a corrosive atmosphere, the step of forming an interference optically variable coating on the first undulating structure comprises: forming the interference optically variable coating on the undulating structure layer, wherein the interference optically variable coating at least covers the first undulating structure; and placing a structure formed by the substrate, the undulating structure layer and the interference optically variable coating in the corrosive atmosphere till the part, covering the second area, of the interference optically variable coating is completely or partially corroded.

Optionally, in the embodiment of the present invention, when the depth-to-width ratio of the first undulating structure is greater than that of the second undulating structure, and/or the outermost layer, far away from the first undulating structure, of the interference optically variable coating reacts with a corrosive atmosphere, the specific volume of the first undulating structure is less than that of the second undulating structure, and the step of forming an interference optically variable coating on the first undulating structure comprises: forming the interference optically variable coating on the undulating structure layer, wherein the interference optically variable coating at least covers the first undulating structure; coating the interference optically variable coating with a coating, wherein the coating at least covers the part, corresponding to the first undulating structure, of the interference optically variable coating, so as to protect the part, covering the first undulating structure, of the interference optically variable coating from being corroded by the corrosive atmosphere; and placing a structure formed by the substrate, the undulating structure layer and the interference optically variable coating in the corrosive atmosphere till the part, covering the second area, of the interference optically variable coating is completely or partially corroded.

Optionally, in the embodiment of the present invention, the interference optically variable coating comprises a first partially transparent layer, a first dielectric layer, a reflection layer, a second dielectric layer and a second partially transparent layer that are overlapped in sequence. Preferably, the first partially transparent layer is different from the second partially transparent layer, and/or the first dielectric layer is different from the second dielectric layer.

Optionally, in the embodiment of the present invention, the interference optically variable coating comprises a first partially transparent layer, a dielectric layer and a second partially transparent layer that are overlapped in sequence. Preferably, the first partially transparent layer is different from the second partially transparent layer.

Optionally, in the embodiment of the present invention, the preparation method further comprises: forming a protective layer and/or a functional coating on the side, opposite to the substrate, of the optical anti-counterfeiting element after the interference optically variable coating is formed. The protective layer and/or the functional coating can be single-layer or multi-layer. Generally, the protective layer and/or the functional coating have/has a protective effect to protect the interference optically variable coating in a use environment from being corroded by external conditions, and also have/has a bonding function with other substrates, such as paper. In addition, when the optical anti-counterfeiting element comprises both the protective layer and the functional coating, the functional coating is formed on the protective layer.

For about the specific explanation for the interference optically variable coating in the embodiment of the preparation method of the optical anti-counterfeiting element provided by the present invention, see the explanation for the corresponding parts in the embodiments of the optical anti-counterfeiting element provided by the present invention.

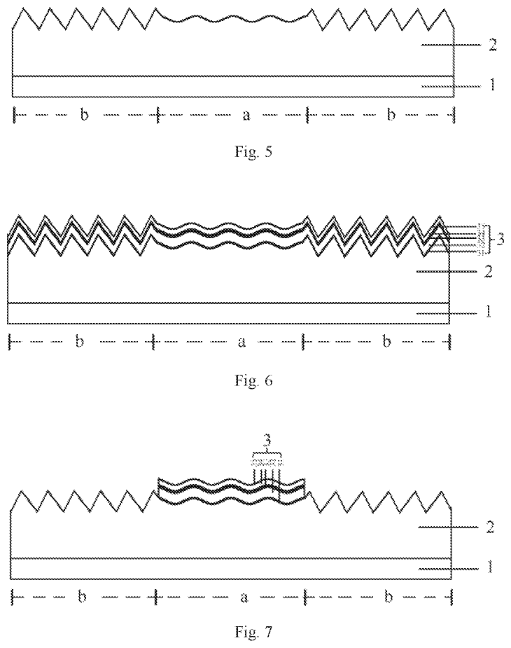

With reference to FIG. 5 to FIG. 7, the following gives an exemplary description of the preparation method of the optical anti-counterfeiting element by using an optical anti-counterfeiting element having the cross section shown in FIG. 3a as an example. In the embodiment, the method can comprise the following steps.

S1: forming an undulating structure layer 2 on a substrate 1, as shown in FIG. 5.

The substrate 1 can be non-transparent or at least partially transparent, or can be a colored dielectric layer, a transparent dielectric film with a functional coating (such as an adhesion enhancing layer) on the surface, or a multi-layer film formed through compounding. When the optical anti-counterfeiting element comprises the substrate 1, the substrate 1 is at least partially transparent, thereby realizing observation from two sides. When the optical anti-counterfeiting element does not comprise the substrate 1, for example, when the optical anti-counterfeiting element is placed on the optical anti-counterfeiting product, the substrate 1 needs to be torn off. In this case, the substrate 1 can be transparent or non-transparent. The substrate 1 is generally made of a thin-film material with good physical and chemical resistance and high mechanical strength. For example, a plastic film such as a polyethylene terephthalate (PET) film, a polyethylene naphthalate (PEN) film or a polypropylene (PP) film can be used to form a flexible substrate. Preferably, the substrate is made of a PET material.

The undulating structure layer 2 has such a property that it can deform under certain temperature and pressure to form a required undulating structure. The undulating structure layer 2 can be made of a thermoplastic material or a radiation curing material. The undulating structure layer 2 comprises a first area a and a second area b. The depth-to-width ratio of a first undulating structure located in the first area a is less than that of a second undulating structure located in the second area b, and/or the specific volume of the first undulating structure located in the first area a is less than that of the second undulating structure located in the second area b. In terms of the specific shapes of the undulating structures, cross sections of the first undulating structure and/or the second undulating structure can be of cosine structures, zigzag structures, cylindrical structures, spherical structures, pyramidal structures, square-wave structures, or a combination thereof. The first undulating structure is used for providing a specific optical effect, so that the shape of the first undulating structure depends on requirements. As the second undulating structure is usually required only for removing the hollowed-out part of a coating with no need of providing a special optical effect, therefore, the second undulating structure is preferably a zigzag grating with a sharp top. The first undulating structure and the second undulating structure can be wholly or partially periodic, wherein the period is greater than 1 um and less than 20 um. Generally, the depth-to-width ratio of the first undulating structure is less than 0.3, and the depth-to-width ratio of the second undulating structure is greater than 0.3. Preferably, the depth-to-width ratio of the first undulating structure is less than 0.2, and the depth-to-width ratio of the second undulating structure is greater than 0.5. Alternatively, the specific volume of the first undulating structure is less than um³/um², and the specific volume of the second undulating structure is greater than 1 um³/um². Preferably, the specific volume of the first undulating structure is less than 0.5 um³/um², and the specific volume of the second undulating structure is greater than 1.5 um³/um².

S2: forming an interference optically variable coating 3 on the surface of the undulating structure layer 2. For example, the interference optically variable coating 3 is formed on the surface of the undulating structure layer 2 through evaporation, as shown in FIG. 6. The interference optically variable coating 3 provides optical effects when being observed from two sides. The interference optically variable coating 3 comprises a five-layer structure. The five-layer structure specifically comprises a first partially transparent layer 31, a first dielectric layer 32, a reflection layer 33, a second dielectric layer 34 and a second partially transparent layer 35 that are overlapped in sequence. The first partially transparent layer 31 is adjacent to the undulating structure layer 2, as shown in FIG. 6. The first partially transparent layer 31 and the second partially transparent layer 35 can be made of chromium, nickel, aluminum, silver, copper, tin, titanium or their alloys. The reflection layer 33 can be made of aluminum, silver, copper, tin, chromium, nickel, titanium, or their alloys. The first dielectric layer 32 and the second dielectric layer 34 can be made of MgF₂, SiO₂, ZnS, TiN, TiO₂, TiO, Ti₂O₃, Ti₃O₅, Ta₂O₅, Nb₂O₅, CeO₂, Bi₂O₃, Cr₂O₃, Fe₂O₃, HfO₂ or ZnO. In the interference optically variable coating 3, the partially transparent layer serves as an absorption layer, the transmittance of the first partially transparent layer 31 and the transmittance of the second partially transparent layer 35 need to be less than 60%. The reflection layer provides a function of reflecting light and can be relatively thick. For example, the reflectivity of the reflection layer is greater than 90% and the transmittance of the reflection layer is less than 10%. To facilitate obtaining of the hollowed-out effect, the first partially transparent layer 31 adjacent to the undulating structure layer 2 is preferably made of aluminum or aluminum alloy.

In addition, the interference optically variable coating 3 can alternatively be of a three-layer structure. The three-layer structure can specifically comprise a first partially transparent layer 31, a dielectric layer 36 and a second partially transparent layer 35 that are overlapped in sequence, as shown in FIG. 3b. The first partially transparent layer 31 and the second partially transparent layer 35 can be made of chromium, nickel, aluminum, silver, copper, tin, titanium or their alloys. The dielectric layer 36 can be made of MgF₂, SiO₂, ZnS, TiN, TiO₂, TiO, Ti₂O₃, TiO, Ta₂O₅, Nb₂O₅, CeO₂, Bi₂O₃, Cr₂O₃, Fe₂O₃, HfO₂ or ZnO. Both the first partially transparent layer 31 and the second partially transparent layer 35 need to provide the functions of reflection layers and absorption layers. Therefore, they can neither be too thick nor be too thin. Generally, the transmittance of the first partially transparent layer 31 and the transmittance of the second partially transparent layer 35 are required to be greater than 30% and less than 60%, preferably, greater than 35% and less than 45%. Similarly, to facilitate obtaining of the hollowed-out effect, the first partially transparent layer 31 adjacent to the undulating structure layer 2 is preferably made of aluminum or aluminum alloy.

In addition, the interference optically variable coating is generally formed using a vapor deposition method. During forming of the interference optically variable coating by the adoption of the vapor deposition method, the interference optically variable coating conformably covers the undulating structure layer, that is, the surface shape of the interference optically variable coating is the same as or basically the same as that of the undulating structure layer.

S3: placing the foregoing structure (the structure formed by the substrate 1, the undulating structure layer 2 and the interference optically variable coating 3) in a certain corrosive atmosphere that can react with one or more layers of coating materials in the interference optically variable coating 3 till the part, located in the second area, of the interference optically variable coating 3 is completely or partially corroded.

If the depth-to-width ratio of the first undulating structure is less than that of the second undulating structure, and the outermost coating (for example, the second partially transparent layer 35 shown in FIG. 3a or the second partially transparent layer 35 shown in FIG. 3b) of the interference optically variable coating 3 does not react with the corrosive atmosphere, and the specific volume of the first undulating structure is greater than that of the second undulating structure, step S3 can be directly executed after step S2. This is because, if the depth-to-width ratio of the first undulating structure is less than that of the second undulating structure, after the interference optically variable coating is formed on the undulating structure layer 2 (for example, through evaporation), the part, located in the first area, of the interference optically variable coating is relatively dense, and the part, located in the second area, of the interference optically variable coating is relatively loose. For another example, if the outermost coating of the interference optically variable coating does not react with the corrosive atmosphere, the outermost coating of the part, located in the first area, of the interference optically variable coating can protect other coatings. Therefore, after execution of step S3, the interference optically variable coating exactly located in the first area can be obtained. For example, the depth-to-width ratio of the first undulating structure is 0.1, the depth-to-width ratio of the second undulating structure is 0.4, the interference optically variable coating 3 is of a five-layer structure which comprises a thin Al layer, a SiO₂ layer, a thick Al layer, another SiO₂ layer, and a Cr layer in sequence. The corrosive atmosphere is an acid or a lye. As the depth-to-width ratio of the first undulating structure is less than that of the second undulating structure, after evaporation, the part, located in the first area, of the interference optically variable coating is relatively dense, and the part, located in the second area, of the interference optically variable coating is relatively loose. In this case, the acid or lye penetrates other coatings in the second area and reacts with aluminum, and the other coatings in the second area are peeled off. The Cr coating on the outer side of the first area can protect the other coatings inside the first area. Therefore, after execution of step S3, the interference optically variable coating exactly located in the first area can be obtained, as shown in FIG. 7.

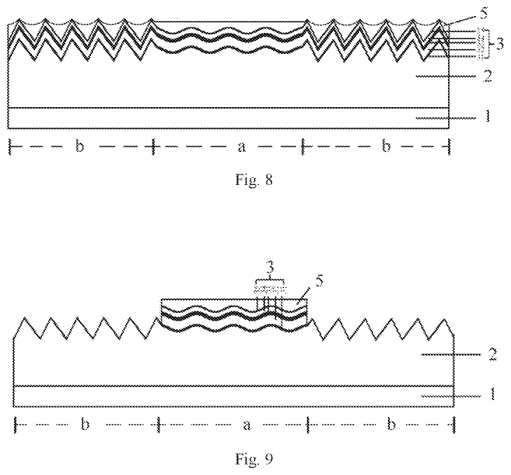

If the depth-to-width ratio of the first undulating structure is less than that of the second undulating structure, and the outermost coating (for example, the second partially transparent layer 35 shown in FIG. 3a or the second partially transparent layer 35 shown in FIG. 3b) of the interference optically variable coating 3 does not react with the corrosive atmosphere, and the specific volume of the first undulating structure is less than that of the second undulating structure, step S3 can be directly executed after step S2, as described above. In addition, if the depth-to-width ratio of the first undulating structure is less than that of the second undulating structure, and the outermost coating (for example, the second partially transparent layer 35 shown in FIG. 3a or the second partially transparent layer 35 shown in FIG. 3b) of the interference optically variable coating 3 does not react with the corrosive atmosphere, and the specific volume of the first undulating structure is less than that of the second undulating structure, after step S2 and before step S3, the method further comprises: coating the interference optically variable coating with a coating 5, as shown in FIG. 8. The coating 5 can effectively protect the part, covering the first undulating structure, of the interference optically variable coating, thereby protecting the part, covering the first undulating structure, of the interference optically variable coating from being corroded by the corrosive atmosphere in step S3. However, the coating 5 cannot effectively protect the part, covering the second undulating structure, of the interference optically variable coating, so that the part, covering the second undulating structure, of the interference optically variable coating is completely or partially corroded by the corrosive atmosphere in step S3. Therefore, after execution of step S3, the interference optically variable coating exactly located in the first area can be obtained.

If the depth-to-width ratio of the first undulating structure is greater than that of the second undulating structure, and/or the outermost coating (for example, the second partially transparent layer 35 shown in FIG. 3a or the second partially transparent layer 35 shown in FIG. 3b) of the interference optically variable coating reacts with the corrosive atmosphere in step S3, the specific volume of the first undulating structure must be less than that of the second undulating structure, and the coating 5 needs to be applied to the interference optically variable coating after step S2 and before step S3, as shown in FIG. 8. This is because, after the coating 5 is applied, due to the specific volume difference between the two undulating structures, the coating 5 can effectively protect the part, covering the first undulating structure, of the interference optically variable coating, thereby protecting the part, covering the first undulating structure, of the interference optically variable coating from being corroded by the corrosive atmosphere in step S3, but the coating 5 cannot effectively protect the part, covering the second undulating structure, of the interference optically variable coating, so that the part, covering the second undulating structure, of the interference optically variable coating is completely or partially corroded by the corrosive atmosphere in step S3. Therefore, after execution of step S3, the interference optically variable coating exactly located in the first area can be obtained. For example, the depth-to-width ratio of the first undulating structure is 0.3, and the specific volume of the first undulating structure is 0.5 um³/um²; the depth-to-width ratio of the second undulating structure is 0.2, and the specific volume of the second undulating structure is 1.5 um/um²; the interference optically variable coating is of a five-layer structure that comprises a thin Al layer, a SiO₂ layer, a thick Al layer, another SiO₂ layer and another thin Al layer in sequence. The corrosive atmosphere is an acid or a lye. In this case, before step S3, the coating 5 of a specific thickness needs to be coated, as shown in FIG. 8. The thickness of the coating can be set according to the specific volume difference of the two undulating structures, so as to effectively protect the part, covering the first undulating structure, of the interference optically variable coating without effectively protecting the part, covering the second undulating structure, of the interference optically variable coating. Therefore, after execution of step S3, the interference optically variable coating exactly located in the first area can be obtained, as shown in FIG. 9. In addition, the coating is generally formed by coating a liquid material and drying it, so that the coating does not conformably cover the interference optically variable coating/undulating structure layer, that is, the surface shape of the coating is obviously different from that of the interference optically variable coating/undulating structure layer, and the surface of the coating tends to be flat.

Based on the foregoing principle, to obtain the coating that is exactly located in the first area, there can be the following eight cases according to the depth-to-width ratio and specific volume differences between microstructures of the first area and the second area (namely, the first undulating structure and the second undulating structure), and whether the outermost coating of the interference optically variable coating can react with the corrosive atmosphere. “1” indicates that the coating exactly located in the first area can be obtained, and “x” indicates that the coating exactly located in the first area cannot be obtained. Different hollowing out modes are used depending on different cases, that is, whether coating of a coating needs to be performed between step S2 and step S3.

However, in some cases (for example, cases 4, 7, and 8), a multi-layer interference coating exactly located in the first area cannot be obtained no matter which hollowing out mode is adopted.

| | Condition | | | | |
|---|---|---|---|---|---|
| | Depth-to- | Specific volume | Does the | | |
| | width ratio | difference between | outermost | Hollowing Out Mode | |
| | difference between | the first and | coating reacts | Perform | Coat a coating |
| | the first and | second | with the | step S3 | after step |
| | second undulating | undulating | corrosive | directly | S2 and then |
| Case | structures | structures | atmosphere | after step S2 | perform step S3 |
| 1 | Less than | Less than | No | ✓ | ✓ |
| 2 | Less than | Less than | Yes | x | ✓ |
| 3 | Less than | Greater than | No | ✓ | x |
| 4 | Less than | Greater than | Yes | x | x |
| 5 | Greater than | Less than | No | x | ✓ |
| 6 | Greater than | Less than | Yes | x | ✓ |
| 7 | Greater than | Greater than | No | x | x |
| 8 | Greater than | Greater than | Yes | x | x |

As the second undulating structure is usually required only for removing the hollowed-out part of the interference optically variable coating with no need of providing a special optical effect. Therefore, the depth-to-width ratio and specific volume of the second undulating structure are designed to be as large as possible.

Therefore, the preparation method of the optical anti-counterfeiting element provided by the embodiment of the present invention achieves an optical effect integrating a double-sided interference optically variable feature and precise hollowing out, that is, the prepared optical anti-counterfeiting element can simultaneously present optically variable effects and image effects when being observed from two sides, and can present a transmitted image when being observed through transmission.

Optionally, in the embodiment of the present invention, the preparation method of the optical anti-counterfeiting element can further comprise the following step: coating the optical anti-counterfeiting element with a protective layer and/or a functional coating 4, as shown in FIG. 3a or FIG. 3b after the interference optically variable coating is formed on the first undulating structure. The protective layer and/or functional coating can be single-layer or multi-layer. The protective layer and/or functional coating generally have/has a protective effect to protect the coating in a use environment from being corroded by external conditions, and also have/has a bonding function with other substrates, such as paper. In addition, when the optical anti-counterfeiting element comprises both the protective layer and the functional coating, the functional coating is formed on the protective layer.

In addition, the preparation method of the optical anti-counterfeiting element provided by the embodiment of the present invention is suitable for making labels, logos, wide strips, transparent windows, security strips with windows, and the like, especially for making thermoprinted labels.

In conclusion, due to the undulating structure layer, the optical anti-counterfeiting element presents image effects when being observed from two sides. Due to the interference optically variable coating, the optical anti-counterfeiting element presents optically variable effects when being observed from two sides. Therefore, the optical anti-counterfeiting element can simultaneously present image effects and optically variable effects when being observed from two sides, that is, the anti-counterfeiting property of the optical anti-counterfeiting element is improved. In addition, when the optical anti-counterfeiting element is observed through transmission, an image defined by the boundary of the second undulating structure can be presented. In this way, anti-counterfeiting dimensions of the optical anti-counterfeiting element are increased, so that the anti-counterfeiting property of the optical anti-counterfeiting element is further improved.

The optional implementations of the embodiments of the present invention have been described in detail in conjunction with the accompanying drawings. However, the embodiments of the present invention are not limited to specific details in the foregoing implementations. Within the technical conception scope of the embodiments of the present invention, a variety of simple variations can be made to the technical solutions of the embodiments of the present invention. These simple variations all fall within the protection scope of the embodiments of the present invention.

It should be noted that, the specific technical features described in the foregoing implementations can be combined in any appropriate manner, provided that they are not contradictory. To avoid unnecessary repetition, the embodiments of the present invention do not separately describe the possible combinations.

In addition, different implementations of the embodiments of the present invention can also be combined in any way. These combinations shall also be regarded as content disclosed in the embodiments of the present invention, provided that they do not violate ideas of the embodiments of the present invention.

1-15. (canceled)

16. An optical anti-counterfeiting element, comprising:
a transparent undulating structure layer, comprising a first undulating structure and a second undulating structure, wherein the first undulating structure and the second undulating structure meet the following conditions: the depth-to-width ratio of the first undulating structure is less than that of the second undulating structure, and/or the specific volume of the first undulating structure is less than that of the second undulating structure; and
an interference optically variable coating, formed on the first undulating structure, wherein the interference optically variable coating presents optically variable effects when being observed from two sides, and an image defined by the boundary of the second undulating structure is presented when the optical anti-counterfeiting element is observed through transmission.

17. The optical anti-counterfeiting element according to claim 16, further comprising: a transparent substrate, wherein the undulating structure layer is formed on at least part of the substrate.

18. The optical anti-counterfeiting element according to claim 16, wherein the interference optically variable coating comprises a first partially transparent layer, a first dielectric layer, a reflection layer, a second dielectric layer and a second partially transparent layer that are overlapped in sequence.

19. The optical anti-counterfeiting element according to claim 18, wherein the first partially transparent layer is different from the second partially transparent layer, and/or the first dielectric layer is different from the second dielectric layer.

20. The optical anti-counterfeiting element according to claim 16, wherein the interference optically variable coating comprises a first partially transparent layer, a dielectric layer and a second partially transparent layer that are overlapped in sequence.

21. The optical anti-counterfeiting element according to claim 20, wherein the first partially transparent layer is different from the second partially transparent layer.

22. An optical anti-counterfeiting product, comprising the optical anti-counterfeiting element according to claim 16.

23. A preparation method of an optical anti-counterfeiting element, comprising:
forming a transparent undulating structure layer on at least part of a substrate, wherein the transparent undulating structure layer comprises a first area and a second area with a first undulating structure and a second undulating structure located therein respectively, and the first undulating structure and the second undulating structure meet the following conditions: the depth-to-width ratio of the first undulating structure is less than that of the second undulating structure, and/or the specific volume of the first undulating structure is less than that of the second undulating structure; and
forming an interference optically variable coating on the first undulating structure, wherein the interference optically variable coating presents optically variable effects when being observed from two sides, and an image defined by the boundary of the second undulating structure is presented when the optical anti-counterfeiting element is observed through transmission.

24. The preparation method according to claim 23, wherein when the depth-to-width ratio of the first undulating structure is less than that of the second undulating structure, the specific volume of the first undulating structure is less than that of the second undulating structure, and the outermost layer, far away from the first undulating structure, of the interference optically variable coating does not react with a corrosive atmosphere, the step of forming an interference optically variable coating on the first undulating structure comprises:
forming the interference optically variable coating on the undulating structure layer, wherein the interference optically variable coating at least covers the first undulating structure; and placing a structure formed by the substrate, the undulating structure layer and the interference optically variable coating in the corrosive atmosphere till the part, covering the second area, of the interference optically variable coating is completely or partially corroded; or
forming the interference optically variable coating on the undulating structure layer, wherein the interference optically variable coating at least covers the first undulating structure; coating the interference optically variable coating with a coating, wherein the coating at least covers the part, corresponding to the first undulating structure, of the interference optically variable coating, so as to protect the part, covering the first undulating structure, of the interference optically variable coating from being corroded by the corrosive atmosphere; and placing a structure formed by the substrate, the undulating structure layer and the interference optically variable coating in the corrosive atmosphere till the part, covering the second area, of the interference optically variable coating is completely or partially corroded.

25. The preparation method according to claim 23, wherein when the depth-to-width ratio of the first undulating structure is less than that of the second undulating structure, the specific volume of the first undulating structure is greater than that of the second undulating structure, and the outermost layer, far away from the first undulating structure, of the interference optically variable coating does not react with a corrosive atmosphere, the step of forming an interference optically variable coating on the first undulating structure comprises:
forming the interference optically variable coating on the undulating structure layer, wherein the interference optically variable coating at least covers the first undulating structure; and
placing a structure formed by the substrate, the undulating structure layer and the interference optically variable coating in the corrosive atmosphere till the part, covering the second area, of the interference optically variable coating is completely or partially corroded.

26. The preparation method according to claim 23, wherein when the depth-to-width ratio of the first undulating structure is greater than that of the second undulating structure, and/or the outermost layer, far away from the first undulating structure, of the interference optically variable coating reacts with a corrosive atmosphere, the specific volume of the first undulating structure is less than that of the second undulating structure, and the step of forming an interference optically variable coating on the first undulating structure comprises:
forming the interference optically variable coating on the undulating structure layer,
wherein the interference optically variable coating at least covers the first undulating structure;
coating the interference optically variable coating with a coating, wherein the coating at least covers the part, corresponding to the first undulating structure, of the interference optically variable coating, so as to protect the part, covering the first undulating structure, of the interference optically variable coating from being corroded by the corrosive atmosphere; and
placing a structure formed by the substrate, the undulating structure layer and the interference optically variable coating in the corrosive atmosphere till the part, covering the second area, of the interference optically variable coating is completely or partially corroded.

27. The preparation method according to claim 23, wherein the interference optically variable coating comprises a first partially transparent layer, a first dielectric layer, a reflection layer, a second dielectric layer and a second partially transparent layer that are overlapped in sequence.

28. The preparation method according to claim 27, wherein the first partially transparent layer is different from the second partially transparent layer, and/or the first dielectric layer is different from the second dielectric layer.

29. The preparation method according to claim 23, wherein the interference optically variable coating comprises a first partially transparent layer, a dielectric layer and a second partially transparent layer that are overlapped in sequence.

30. The preparation method according to claim 29, wherein the first partially transparent layer is different from the second partially transparent layer.
